(19) United States
(12) Patent Application Publication
(10) Pub. No.: US 2017/0197376 A1
(43) Pub. Date: Jul. 13, 2017

(54) CASE ERECTOR AND ASSOCIATED CARTON FLAP GRIPPING SYSTEM

(71) Applicant: David S. Porteous, Chilliwack (CA)

(72) Inventor: David S. Porteous, Chilliwack (CA)

(21) Appl. No.: 14/993,556

(22) Filed: Jan. 12, 2016

(51) Int. Cl. B31B 1/78

(52) U.S. Cl. CPC B31B 1/78; B31B 2201/281

(57) ABSTRACT

A carton flap gripping arrangement includes an operating panel, pin holder and movable dome arrangement. The movable dome can be selectively urged into a grip position for holding a carton flap and can move to a non-grip position to facilitate insertion of the pins into the edge of the carton flap.

### TECHNICAL FIELD

The present application relates to a flap gripper for a case erector and, more particularly, to a pin type gripper with a movable dome.

### BACKGROUND

Pin type grippers that employ a combination of substantially straight pins and cooperating domes have been used successfully in case opening systems for corrugated boxes many years. Corrugated boxes are boxes generally make from corrugated board composed of a pair of outer liner with a corrugated medium there between. The corrugated medium connects and holds the liners in substantially parallel spaced relationship. These pin type gripper systems rely on a series of pins that are carefully aligned with domes and that penetrate the open end of panels (flaps) on the flattened or folded corrugated box or carton (i.e. between the liners) in a direction parallel to the longitudinal axis of the corrugations in the medium. The pins combine with their respective adjacent domes to grip the liner there between.

U.S. Pat. No. 7,316,643 and U.S. Pat. No. 7,422,552 are representative of such pin holder and dome carton flap griping systems. The '643 patent discloses and claims an embodiment in which the dome is movable, which aids in assuring proper gripping of the carton blanks during the unfolding or erecting of the blanks. However, improvements in such systems are regularly sought.

It would be desirable to provide an improved dome mounting system for such gripping arrangements.

### SUMMARY

In one aspect, a gripping arrangement for handling carton flaps includes an operating panel including an inner side and an outer side, a pin holder located on the operating panel and including at least one pin extending therefrom and terminating in a free end extending along and spaced from the inner side of the operating panel. The operating panel includes a through opening with a first portion and a second portion, the first portion extending from the outer side toward the inner side and the second portion extending from the inner side toward the outer side. The first portion has a first cross-sectional area and the second portion has a second cross-sectional area, wherein the first cross-sectional area is larger than the second cross-sectional area such that a first shoulder is defined within the through opening, the shoulder facing the outer side of the operating panel. A dome member is movably positioned within the through opening and includes a front dome portion and a rear retention portion. The front dome portion is sized for passage through the second portion of the through opening so as to extend beyond the inner side of the operating panel toward the pin, and the rear retention portion is sized to define a second shoulder that engages the first shoulder to prevent complete passage of the dome member from the outer side of the operating panel through the through opening to the inner side of the operating panel.

In another aspect, a case erecting system includes a gripping arrangement for handling carton flaps, where the gripping arrangement includes an operating panel including an inner side and an outer side, a pin holder located on the operating panel and including at least one pin extending therefrom and terminating in a free end extending along and spaced from the inner side of the operating panel, the operating panel including a through opening from the outer side to the inner side. A dome member is positioned within the through opening for movement between a grip position in which a dome surface of the dome member is located toward the pin member and a non-grip position in which the dome surface is located away from the pin member. A pneumatic actuation assembly is provided for selectively urging the dome member into the grip position by applying gaseous pressure from the outer side of the operating panel.

In a further aspect, a case erecting system includes a gripping arrangement for handling carton flaps, the gripping arrangement including an operating panel including an inner side and an outer side, a pin holder located on the operating panel and including at least one pin extending therefrom and terminating in a free end extending along and spaced from the inner side of the operating panel, the operating panel including a through opening from the outer side to the inner side. A dome member is positioned within the through opening for movement between a grip position in which a dome surface of the dome member is located toward the pin member and a non-grip position in which the dome surface is located away from the pin member. A pneumatic assembly is provided for selectively urging the dome member into the grip position by applying gaseous pressure. A controller is operatively connected with the pneumatic assembly, the controller configured to cause the pneumatic assembly to apply gaseous pressure when a carton is being opened, the controller configured to remove gaseous pressure when a carton flap is initially being received by the pin member such that the dome member can move toward the non-grip position under interaction with the carton flap in order to facilitate the carton flap moving into position on the pin member.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is an isometric view showing a prior art carton flap gripping system;

FIGS. 2 and 3 are views showing how pins operate to grip the panel of a box or the like;

FIG. 4 is a perspective view a carton gripping device;

FIG. 5 is a front view of an operating panel of the gripping device;

FIG. 6A is a cross-sectional view of on pin and dome arrangement on the panel;

FIG. 6B is an enlarged view of part of the cross-section of FIG. 6A; and

FIG. 7 is a partially exploded view of the operating panel and dome arrangement.

### DETAILED DESCRIPTION

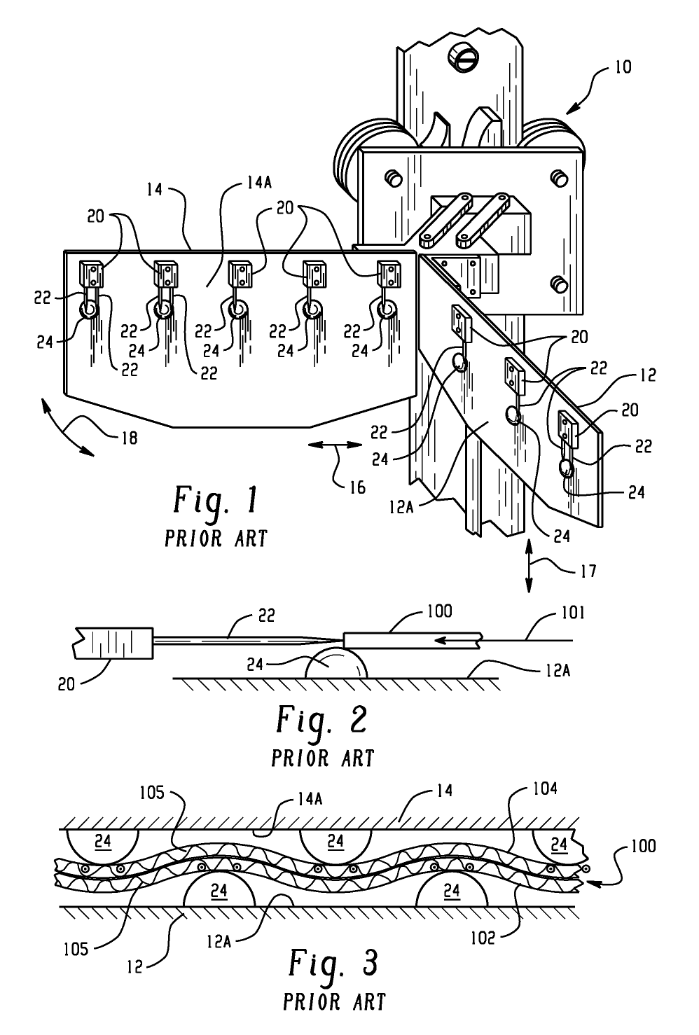

Referring to FIG. 1, the prior art device shown is described in full in U.S. Pat. No. 7,316,643. The device 10 comprises a pair of hinged operating panels or jaws 12 and 14 which as indicated by the arrow 16 are moveable from a receiving or pick-up position where they pick up a knocked down carton/case blank to an advanced position directly over a bottom flap folding station into which the squared blank is lowered as indicated by the arrow 17 to fold the bottom flaps. The jaw or operating panel 14 in this device is pivoted as indicated by the arrow 18 respective to the jaw 12 between the open squaring position shown in FIG. 1 and a spaced but substantially parallel receiving position wherein the jaw 14 is substantially parallel to the jaw 12.

The knocked down blanks 100 (only a portion shown—see FIGS. 2 and 3) formed of interconnected panels and flaps that are made of laminate (in the illustration are made from corrugated cardboard) composed of an outer layer 102 and an inner layer 104 generally called liners and an intermediate layer interconnecting the layers 102 and 104 that is generally in the form of a corrugated medium 105. When the jaws 12 and 14 are in the parallel receiving position (not shown) the blanks 100 are moved into a gripping position as indicated by the arrow 101 and gripped by the grippers 20 some of which are shown with a single gripping pin 22 and others with a pair of gripping pins 22 and one with no gripping pin see gripper 20A (see FIG. 1).

Each gripper 20 is mounted on its jaw or operating panel 12 or 14 with its gripping pin(s) substantially parallel to the surface 12A or 14A of the operating panels 12 or 14 and are positioned to cooperate with dome shaped projections 24 extending from the surface 12A or 14A to grip the adjacent surface layer (i.e. the outer layer 102 on opposite sides of the blank 100 in FIG. 3) between the dome and its adjacent gripping pin to hold the flaps.

In operation as the blank 100 is moved as indicated by the arrow 101 and the pins 22 pass inside the panel immediately adjacent to the adjacent surface panel (outside layer 102) while the panels are being deformed by the domes 24 to an undulating shape in the illustration in FIG. 3 which facilitates entry of the pins 22. When the panels 12 and 14 are subsequently moved to the squaring position of FIG. 1, the box/blank is unfolded.

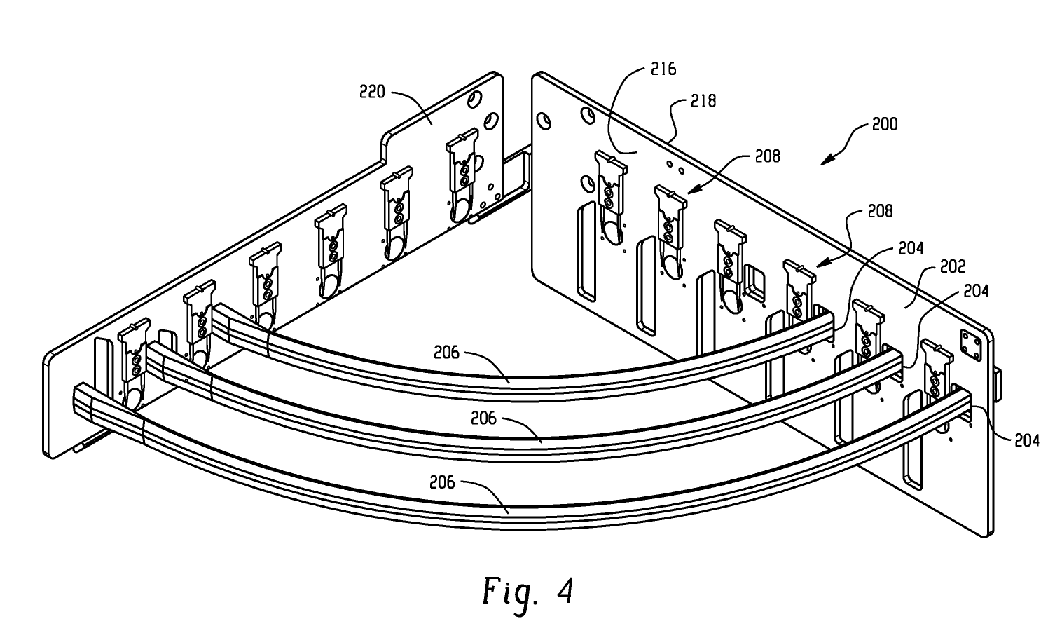

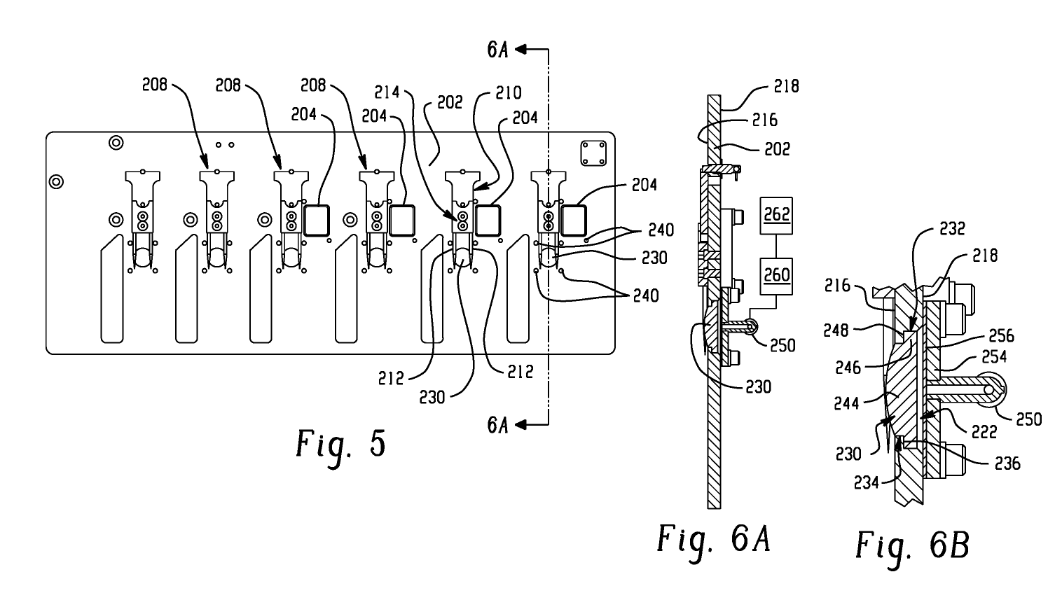

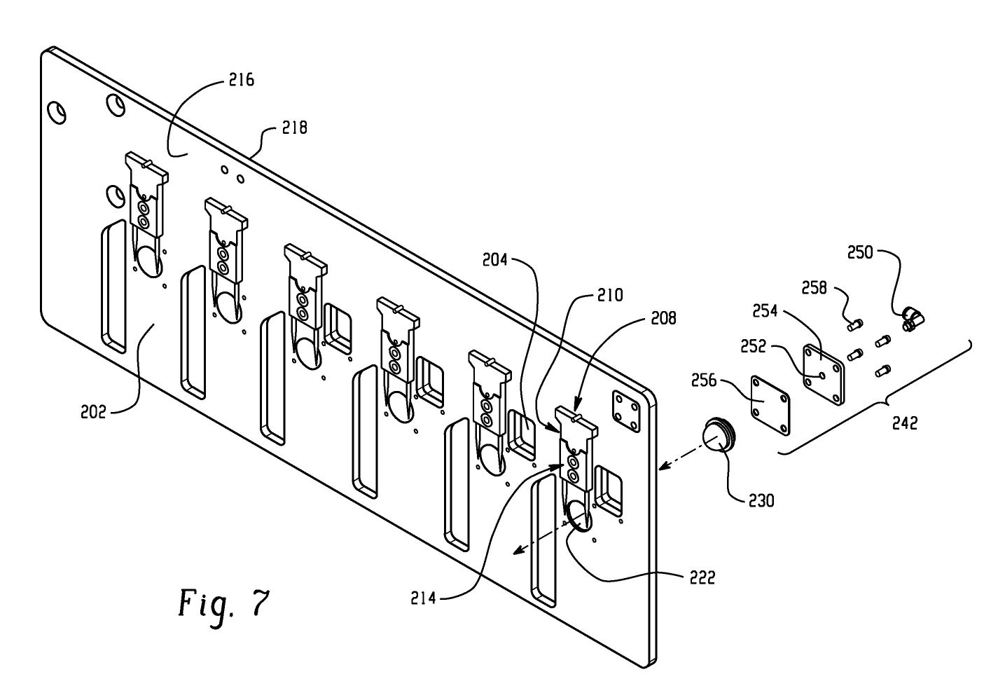

Referring now to FIGS. 4-7, FIG. 4 is the perspective view of the whole carton flap gripping device or arrangement 200, which includes flat pin holding block or operating panel 202. On the pin holding panel 202 there are a plurality (e.g., two or more, such as three or more) of square holes 204 which are used to mount respective curved rails 206. A plurality of flap holding or gripping devices 208 are mounted on the pin holding panel 202. Each flap holding device includes a pin holder 210 and at least one pin 212. Typically each pin holder 210 includes two pins 212 that extend from the lower end of the pin holder. Each pin 212 has a free end which passes through a pin holding body 214 and inserts into the corrugated edge of the flap in order to hold the flap of the carton (as described above). The operating panel 202 includes an inner side 216 (facing toward a curved path defined by rails 206 that leads to a second operating panel 220) and an outer side 218 (facing away from the curved path). Each pin holder 210 is located on the inner side of the operating panel and each pin 212 extends therefrom and terminates in a free end that extends along and is paced from the inner side of the operating panel.

Below each pin holding body 214, a through hole 222 is located on the operating panel. Each hole 222 receives a dome member 230 that interacts with the pins 212 to facilitate gripping a carton flap. The dome member is movable to facilitate both proper gripping of flaps and to enable the pins to readily be inserted into the flap edges. As seen in FIGS. 6A and 6B, each through opening 222 includes an outer portion 232 and an inner portion 234, where the outer portion 232 extends from the outer side 218 toward the inner side 216 of the panel and the inner portion 234 extends from the inner side 216 toward the outer side 218. Inner portion 234 has a cross-sectional area that is smaller than the cross-sectional area of outer portion 232, such that a shoulder 236 is defined within the through opening, with the shoulder 236 facing the outer side of the operating panel. In the illustrated embodiment the shoulder 236 is annular in shape, but variations are possible.

A set (e.g., 4) of small holes 240 surrounds each through hole 222 and is used to attach a pressurization assembly 242 to the outer side of the panel over the through opening, which maintains the dome member within the hole 222. The dome member 230 is movably positioned within the through opening 222 and includes a front dome portion 244 and a rear retention portion 246, where the front dome portion 244 is sized for passage through the second portion 234 of the through opening so as to extend beyond the inner side of the operating panel toward the pin(s) 212. The rear retention portion 246 is sized to define a shoulder 248 that engages the shoulder 236 to prevent complete passage of the dome member 230 from the outer side of the operating panel through the through opening to the inner side of the operating panel. The pressurization assembly 242 includes an air feed 250, which connects to a passage 252 provided in a stiff plate 254 that is attached at the outer side of the of the operating panel over the through opening. A flexible plate 256 is disposed between the stiff plate 254 and the dome member 230. Bolts or screws 258 connect the assembly to the holes 240.

In operation, the pneumatic assembly provides a pressurization system for selectively supplying pressurized fluid to urge the dome member 230 into a seated position in which the shoulder 248 engages the shoulder 236. This seated position places the dome surface of the dome member in a grip position toward the pin(s) 212 for adequate and effective gripping of a carton flap that is received on the pin(s). When pressurized fluid is not being supplied the dome member 230 can be moved into an unseated position in which the shoulder 248 is spaced from the shoulder 236, and thus the dome surface of the dome member is in a non-grip position away from the pin(s). When fluid pressure (e.g., compressed air from compressed air source 260) is applied via the air feed 250, the gaseous pressure applied to the rear side of the flexible plate 256 thereby causes the flexible plate 256 to urge the dome member 230 into the grip position. In the absence of the fluid pressure, the dome member can move toward the non-grip position, such as when a carton flap is being moved onto the pin(s) and the carton flap interacts with the dome member 230.

A controller 262 is operatively connected with the pneumatic assembly and may be configured to cause the pneumatic assembly to apply gaseous pressure when a carton is being opened (e.g., after the carton flap has been inserted onto the pins). The controller 262 is configured to remove gaseous pressure when a carton flap is initially being received by the pin(s) such that the dome member can move toward the non-grip position under interaction with the carton flap in order to facilitate the carton flap moving into position on the pin member.

It is to be clearly understood that the above description is intended by way of illustration and example only, is not intended to be taken by way of limitation, and that other changes and modifications are possible. Although not described in detail above, operating panel 220 may include similar pneumatic assemblies in connection with its dome members.

What is claimed is:

1. A gripping arrangement for handling carton flaps, the gripping arrangement comprising:
an operating panel including an inner side and an outer side, a pin holder located on the operating panel and including at least one pin extending therefrom and terminating in a free end extending along and spaced from the inner side of the operating panel, the operating panel including a through opening with a first portion and a second portion, the first portion extending from the outer side toward the inner side and the second portion extending from the inner side toward the outer side, the first portion having a first cross-sectional area and the second portion having a second cross-sectional area, wherein the first cross-sectional area is larger than the second cross-sectional area such that a first shoulder is defined within the through opening, the shoulder facing the outer side of the operating panel;
a dome member movably positioned within the through opening, the dome member including a front dome portion and a rear retention portion, the front dome portion sized for passage through the second portion of the through opening so as to extend beyond the inner side of the operating panel toward the pin, the rear retention portion sized to define a second shoulder that engages the first shoulder to prevent complete passage of the dome member from the outer side of the operating panel through the through opening to the inner side of the operating panel.

2. The gripping arrangement of claim 1, further comprising:
a pressurization system for selectively supplying pressurized fluid to urge the dome member into a seated position in which the second shoulder engages the first shoulder, wherein when pressurized fluid is not being supplied the dome member can be moved into an unseated position in which the second shoulder is spaced from the first shoulder.

3. The gripping arrangement of claim 2 wherein the pressurization system includes a passage provided in a stiff plate that is attached at the outer side of the of the operating panel over the through opening, and a flexible plate disposed between the stiff plate and the dome member, the flexible plate urging the dome member into the seated position when pressurized fluid is supplied via the passage.

4. The gripping arrangement of claim 2 wherein the pressurized fluid is pressurized air.

5. The gripping arrangement of claim 1 wherein the operating panel includes multiple pin holders, multiple corresponding through openings and multiple corresponding dome members.

6. A case erecting system including a gripping arrangement for handling carton flaps, the gripping arrangement comprising:
an operating panel including an inner side and an outer side, a pin holder located on the operating panel and including at least one pin extending therefrom and terminating in a free end extending along and spaced from the inner side of the operating panel, the operating panel including a through opening from the outer side to the inner side;
a dome member positioned within the through opening for movement between a grip position in which a dome surface of the dome member is located toward the pin member and a non-grip position in which the dome surface is located away from the pin member;
a pneumatic actuation assembly for selectively urging the dome member into the grip position by applying gaseous pressure from the outer side of the operating panel.

7. The case erecting system of claim 6 wherein the through opening includes a shoulder facing toward the outer side of the operating panel and the dome member includes an enlarged rear portion that defines a second shoulder that faces toward the first shoulder, wherein the second shoulder engages the first shoulder when the dome member is in the grip position.

8. The case erecting system of claim 6 wherein the pneumatic actuation assembly includes a rigid plate attached at the outer side of the of the operating panel over the through opening, a flexible plate disposed between the stiff plate and the dome member, and an gaseous fluid passage through the stiff plate for applying gaseous pressure to a rear side of the flexible plate to thereby cause the flexible plate to urge the dome member into the grip position.

9. The case erecting system of claim 6 wherein the operating panel includes multiple pin holders, multiple corresponding through openings, multiple corresponding dome members and multiple corresponding pneumatic actuation assemblies.

10. The case erecting system of claim 6 wherein:
the operating panel is a first operating panel, the gripping arrangement further includes a second operating panel, wherein the second operating panel is pivotable relative to the first operating panel between a carton closed position and a carton opened position, wherein the second operating panel includes:
an inner side and an outer side, a second pin holder located on the second operating panel and including at least one pin extending therefrom and terminating in a free end extending along and spaced from the inner side of the second operating panel, the second operating panel including a through opening from the outer side to the inner side of the second operating panel;
a second dome member positioned within the through opening of the second operating panel for movement between a grip position in which a dome surface of the second dome member is located toward the pin member of the second pin holder and a non-grip position in which the dome surface of the second dome member is located away from the pin member of the second pin holder; and
a second pneumatic actuation assembly for selectively urging the second dome member into the grip position by applying gaseous pressure from the outer side of the second operating panel.

11. A case erecting system including a gripping arrangement for handling carton flaps, the gripping arrangement comprising:
an operating panel including an inner side and an outer side, a pin holder located on the operating panel and including at least one pin extending therefrom and terminating in a free end extending along and spaced from the inner side of the operating panel, the operating panel including a through opening from the outer side to the inner side;
a dome member positioned within the through opening for movement between a grip position in which a dome surface of the dome member is located toward the pin member and a non-grip position in which the dome surface is located away from the pin member;
a pneumatic assembly for selectively urging the dome member into the grip position by applying gaseous pressure; and
a controller operatively connected with the pneumatic assembly, the controller configured to cause the pneumatic assembly to apply gaseous pressure when a carton is being opened, the controller configured to remove gaseous pressure when a carton flap is initially being received by the pin member such that the dome member can move toward the non-grip position under interaction with the carton flap in order to facilitate the carton flap moving into position on the pin member.

12. The system of claim 11 wherein the through opening includes a shoulder facing toward the outer side of the operating panel and the dome member includes an enlarged rear portion that defines a second shoulder that faces toward the first shoulder, wherein the second shoulder engages the first shoulder when the dome member is in the grip position.

13. The system of claim 11 wherein the pneumatic assembly includes a rigid plate attached at the outer side of the of the operating panel over the through opening, a flexible plate disposed between the stiff plate and the dome member, and a gaseous fluid passage through the stiff plate for applying gaseous pressure to a rear side of the flexible plate to thereby cause the flexible plate to urge the dome member into the grip position

14. The system of claim 11 wherein the operating panel includes multiple pin holders, multiple corresponding through openings, multiple corresponding dome members and multiple corresponding pneumatic actuation assemblies, and the controller is operatively connected with each pneumatic assembly for control thereof.
